(19) United States
(12) Patent Application Publication
(10) Pub. No.: US 2026/0318340 A1
(43) Pub. Date: Oct. 15, 2026

(54) ROD CONNECTOR DEVICE FOR VARIABLE CONNECTION AT A STABLE ANGLE OF A FIRST ROD AND A SECOND ROD OF A LINKAGE TO ONE ANOTHER WITH AN ARRESTING UNIT FOR FINDING A SETTABLE INTENDED ANGULAR SETTING AGAIN

(71) Applicant: INSORS GMBH, Münchwald (DE)

(72) Inventor: Gregor Horacek, Ransbach-Baumbach (DE)

(21) Appl. No.: 19/336,960

(22) Filed: Sep. 23, 2025

(30) Foreign Application Priority Data
Sep. 23, 2024 (EP) 24201960.2

(51) Int. Cl. F16B 7/04; A61G 5/10

(52) U.S. Cl. CPC F16B 7/0493; A61G 5/1094

(57) ABSTRACT

The invention relates to a rod connector device for variable connection at a stable angle of a first rod and a second rod of a linkage. The invention further relates to a method for holding a terminal on a wheelchair. The rod connector device has an arresting unit for finding a settable intended angular setting again. The rod connector device further comprises a first receiving unit having a first rod receptacle for the first rod, and a second receiving unit having a second rod receptacle for the second rod, wherein the receiving units are coupled to one another and can be transferred from a loose position into a clamping position, wherein the receiving units are rotatable about an axis of rotation in the loose position to vary an angle of the receiving units, wherein, in the clamped position, the receiving units are fixed in place without the ability to rotate.

### CROSS-REFERENCE TO RELATED APPLICATION

This application claims priority of European Patent Application No. 24201960.2 filed Sep. 23, 2024, the entire content of which is incorporated herein by reference.

### TECHNICAL FIELD

The invention relates to a rod connector device for variable connection at a stable angle of a first rod and a second rod of a linkage. The invention further relates to a method for holding a terminal on a wheelchair. The rods of the linkage may be solid rods or hollow rods. The first rod and/or the second rod are preferably in the form of a hollow rod, in particular a tube. The linkage may in particular be a tube linkage.

### BACKGROUND

Technical rehabilitation includes the field of “assisted communication”. This is understood essentially to mean the use of digital terminals, such as systems controlled by the eyes and tablet computers that have software applications for speech output, which allow people with limited communication abilities (speech) to communicate with the surrounding area. These terminals are attached to a wheelchair, a table, a bed, or a floor stand by means of special mounts. The mounts usually have a linkage with at least two rods and a rod connector device connecting the two rods. If necessary, the mount has special adapters for mounting the linkage on wheelchairs, floor stands, tables or beds.

However, the present invention is not restricted to the aforementioned area of application. For instance, the present invention can also be used in the case of rods for use with mounts for photographic apparatuses, cameras, etc.

It is essential to correctly and stably align or adjust the terminals relative to the person using the terminal, in order to enable correct interaction between the terminal and the user and thus allow the user to correctly and comfortably use the terminal. In this case, it is necessary to align the rods of the linkage, which serve to mount the terminal for example on a wheelchair and/or a bed, relative to one another, to this end it being necessary to adjust the angle of the rods relative to one another. For this, use is generally made of rod connector devices, which connect a first rod and a second rod to one another. Such rod connector devices generally have a first receiving unit and a second receiving unit coupled to the first receiving unit, the first receiving unit having a first rod receptacle for the first rod and the second receiving unit having a second rod receptacle for the second rod. The first receiving unit and the second receiving unit are designed in such a way that the first receiving unit and the second receiving unit can be transferred from a loose position into a clamping position, the receiving units being rotatable in relation to one another about an axis of rotation in the loose position in order to vary an angle of the receiving units in relation to one another. By contrast, in the clamping position the receiving units are intended to be fixed in place without the ability to rotate. Such rod connector devices are often also referred to as rod joints or 360° joints. In the case of linkages in the form of tube linkages, such joints are also referred to as tube joints.

The exact angular alignment of the first receiving unit and the second recording unit in relation to one another is essential in order to allow the terminal to be used correctly. Often, when they are in use, thus in a use position, the first rod and the second rod are aligned approximately perpendicularly in relation to one another, for example the angle between the first rod and the second rod is between 70° and 110°.

In practice, it is often necessary or desirable to swivel the first rod and the second rod into a space-saving swivelled-in position. As a result, the first rod, second rod and rod connector device as a whole can be stowed for example so as to save space. For this purpose, the first receiving unit and the second receiving unit are transferred from the clamping position into the loose position and then swivelled in relation to one another about the axis of rotation in order to transfer the first and the second rod into an angular position in which the first rod and the second rod extend in parallel next to one another. In the swivelled-in position, a particularly compact arrangement of the first rod, second rod and rod connector device as a whole can be achieved. The problem here is swivelling the first and the second rod from the swivelled-in position back into the use position exactly, for example in order to optimally align a terminal held on the second rod in relation to the user again. This process can be very complex and time-consuming. It is often made difficult by the fact that persons with motor impairments cannot perform such an adjustment process themselves and are therefore dependent on the help of third parties. In particular when only a few third parties, for example carers, have to perform the adjustment process for the terminal holders of multiple persons, the overall time and thus the wait for the individual person can be very lengthy.

Against this background, there is a need for a rod connector device that makes it possible to find a settable intended angular setting again easily and reproducibly. Furthermore, an object of the invention is to specify an improved method in this respect for holding a terminal on a wheelchair.

### SUMMARY

These objects are achieved by the subject matter of the independent claims. The dependent claims relate to advantageous refinements.

The rod connector device according to the invention serves for variable connection at a stable angle of a first rod and a second rod of a linkage to one another. In this respect, a connection between the first rod and the second rod in various angular settings can be established via the rod connector device, in particular in order to align the orientation and position of a mount, which is directly or indirectly connected to one of the rods, in relation to a user and then fix the mount in place.

The rod connector device comprises:
a first receiving unit, the first receiving unit having a first rod receptacle for the first rod,
a second receiving unit, the second receiving unit having a second rod receptacle for the second rod.

The first receiving unit and the second receiving unit are coupled to one another and can be transferred from a loose position into a clamping position, wherein the receiving units are rotatable in relation to one another about an axis of rotation in the loose position in order to vary an angle of the receiving units in relation to one another, wherein, in the clamped position, the receiving units are fixed in place without the ability to rotate. The rod connector further has an arresting unit for finding a settable intended angular setting again. The arresting unit has a latching element, which is mounted in the first receiving unit, and a counter element, which is mounted in the second receiving unit and has a latching structure for the latching element. A spring-force element applies a spring force to the latching element in the direction of the counter element, wherein, when the first receiving unit and the second receiving unit are rotated in relation to one another about the axis of rotation in the intended angular setting, the latching element arrestingly interacts with the latching structure of the counter element. The counter element can be transferred from a locking state to an adjustment state, wherein, in the adjustment state, the counter element is mounted in the second receiving unit with the ability to rotate about the axis of rotation in order to set the intended angular setting by changing an angular position of the latching structure in the second receiving unit, wherein, in the locking state, the counter element is mounted in the second receiving unit without the ability to rotate, in order to lock the set intended angular setting in place.

In the locking state of the counter element, the counter element is therefore fixed in place in the second receiving unit in terms of its angular position, so that as a result the angular position of the latching structure is also fixed, the angular position of the latching structure in the second receiving unit corresponding to the intended angular setting. In order to find again the intended angular setting between the first receiving unit and the second receiving unit, and thus between the first rod and the second rod, during use of the rod connector device, in the loose position the first receiving unit and the second receiving unit can be rotated in relation to one another about the axis of rotation, wherein, in the intended angular setting defined by the latching structure, the latching element arrestingly interacts with the latching structure and thereby indicates that the intended angular setting has been reached. For example, in the intended angular setting the latching element and the latching structure can interact in such a way that the latching element audibly and noticeably latches into the latching structure. In addition, it is by all means conceivable for the latching structure and the latching element to interact with one another in the intended angular setting in such a way that rotating the receiving units in relation to one another out of the intended angular setting is linked to an increased expenditure of force for releasing the latching structure and the latching element from the latched position present in the intended angular setting or for making rotation beyond the intended angular setting identifiable to the user.

As soon as the intended angular setting is reached, the receiving units can be transferred from the loose position into the clamping position in order to fix the receiving units in place in relation to one another in the intended angular setting, without the ability to rotate. In this connection, it should be noted in particular that the arresting unit is preferably not configured to fix the first receiving unit and the second receiving unit in place in the intended angular setting without the ability to rotate. Rather, it is considered particularly advantageous if the arresting unit is only used to indicate the intended angular setting or find the latter again. This makes it possible to transfer the rod connector device for example into a folded-up arrangement that does not match the intended angular setting, without the arresting unit preventing the rotation.

The first rod and/or the second rod may be a solid rod or a hollow rod. The first rod and/or the second rod are preferably in the form of a hollow rod, in particular a tube. The linkage may in particular be a tube linkage.

In a particularly preferred embodiment, it is provided that a material of the first receiving unit and of the second receiving unit is a metal material, in particular aluminium. The use of a metal material has proven to be advantageous, in order to ensure the necessary forces stay without the ability to do damage or cause deformation.

The first and the second rod preferably, but not necessarily, have a round cross section.

The latching element is preferably formed outside the axis of rotation of the rod connector device. Further, it is considered advantageous when the latching structure of the counter element is formed outside the axis of rotation of the rod connector device.

The spring-force element preferably acts in the axial direction, with the result that the latching element moves in the axial direction of the axis of rotation.

In a particularly preferred embodiment, it is provided that the counter element has a single latching structure. Accordingly, there is only one single angular setting, specifically the intended angular setting, in which the latching element arrestingly interacts with the latching structure of the counter element.

In a particularly preferred embodiment, it is provided that the arresting unit has a bracing element, wherein the bracing element has a bracing portion, wherein the second receiving unit has a pressing surface for the counter element, wherein the bracing element is mounted in the second receiving unit with the ability to move axially, wherein an axial movement of the bracing element causes the counter element to be transferable from the adjustment state into the locking state and vice versa, wherein, in the locking state, the counter element is clamped in the second receiving unit between the bracing portion and the pressing surface, without the ability to rotate owing to a force fit, i.e. frictional engagement, with the bracing portion and with the pressing surface, and, in the adjustment state, the counter element is rotatable with respect to the second receiving unit about the axis of rotation.

It is considered advantageous, in particular with regard to pre-mounting, when the counter element is mounted on the bracing element.

The counter element is accordingly locked in the second receiving unit by bracing the counter element between the bracing portion of the bracing element and the pressing surface of the second receiving unit. By contrast, in the adjustment state the counter element can be rotated in relation to the second receiving unit about the axis of rotation. In the adjustment state, the angular setting of the latching structure and thus the intended angular setting can be changed by rotating the counter element about the axis of rotation in relation to the second receiving unit.

In this case, it is considered particularly advantageous when, in the adjustment state, the latching element and the latching structure or the counter element are configured such that these two elements also arrestingly interact in the adjustment state. As a result, when the counter element is in the adjustment state and the receiving units are in the loose position, rotating the receiving units in relation to one another about the axis of rotation allows the latching element, which rotates about the axis of rotation together with the first receiving unit, to carry along the counter element so that the counter element follows the rotation of the latching element or of the first receiving unit in relation to the second receiving unit, as a result of which an angular position of the latching structure can be easily changed. If the desired intended angular setting between the first receiving unit and the second receiving unit or the first rod and the second rod is reached, the receiving units can be transferred into the clamped position in order to fix them in place in relation to one another without the ability to rotate. Subsequently, the bracing element can be axially moved in such a way that the counter element transitions from the adjustment state into the locking state, as a result of which the angular position of the latching structure in the second receiving unit is fixed, this angular position of the latching structure corresponding to the currently set angle between the first receiving unit and the second receiving unit, so that the currently set angle is defined as the intended angle or intended angular setting.

In a particularly preferred embodiment, it is provided that the counter element is rotatably mounted on the bracing element.

In one advantageous refinement, it is provided that the bracing portion has a variable outside diameter forming an outer cone, and wherein the counter element has a variable inside diameter forming an inner cone corresponding to the outer cone. The conical shape allows a particularly high axial force absorption and thus a particularly strong force fit or frictional engagement for holding the counter element in the locking state without the ability to rotate.

In addition, a conical design has the advantage that it self-centres in the locking state, as a result of which a particularly stable position of the counter element in the radial direction is ensured. In this way, a particularly accurate radial alignment of the latching structure in relation to the latching element can be achieved, as a result of which the intended angular setting can be found again with increased accuracy.

It is considered particularly advantageous when the bracing element is attached to a mounting element, wherein the mounting element has at least one threaded portion, wherein a screw element is screwed to the threaded portion, wherein rotational tightening of the screw element leads to an axial movement of the bracing portion in the direction of the pressing surface.

In one preferred refinement, it is provided that the screw element is in the form of a screw with a head portion and the head portion of the screw element is supported during the tightening operation on the second receiving unit on a side of the second receiving unit facing away from the bracing portion.

In one preferred refinement, it is provided that the at least one threaded portion is formed parallel to the axis of rotation.

It is considered particularly advantageous when the mounting element is mounted in a cutout formed in the second receiving unit. In this case, it is considered particularly advantageous when a depth of the cutout is such that a gap remains between a bottom of the cutout and the mounting element in the locking state, in order to ensure that the counter element abuts the pressing surface and as a result is clamped between the pressing surface and the bracing portion.

It is considered particularly advantageous when the bracing element is mounted in the second receiving unit without the ability to rotate.

In a particularly preferred embodiment, it is provided that the counter element is annular. An annular shape of the counter element can be considered advantageous in that tilting of the counter element in the second receiving unit is avoided and accordingly the counter element is mounted in the second receiving unit in a particularly stable position. In one embodiment, in which the counter element is clamped between the pressing surface and the bracing portion in the locking state, an annular shape has the effect that the abutting surfaces are subjected to as great and uniform as possible loading, as a result of which local pressure peaks are avoided. Further, an annular shape has the advantage that a pressing surface interacting with the latching element can be formed on the annular counter element and the pressing surface can be uniform all around the axis of rotation apart from the latching structure. As a result, when the first receiving unit and the second receiving unit are being rotated in relation to one another, the intended angular setting can be found again particularly easily, since a significant change in the position of the latching element will occur only in the region of the latching structure. This change in position can for example be visually identifiable and/or audible and/or perceptible.

In a particularly preferred embodiment, it is provided that, in the adjustment state, the latching element interacts with the latching structure of the counter element in such a way that, when the first receiving unit and the second receiving unit are rotated in relation to one another about the axis of rotation, the counter element is carried along by the latching element.

It is considered particularly advantageous when the latching structure is in the form of a recess, for example in the form of a depression or a blind hole, or a through-hole. Such a latching structure can be produced easily and ensures a monostable latching position, in particular when the latching element is in the form of a latching pin.

A through-hole may be formed for example by a through-bore in the counter element.

It is considered particularly advantageous when the counter element is in the form of a disc.

In one advantageous refinement, it is provided that the latching element and the latching structure are designed in such a way that, in the locking state, it is possible to rotate the first receiving unit and the second receiving unit in relation to one another out of the intended angular setting by overcoming a latching resistance caused by the latching interaction of the latching element with the latching structure.

Such an embodiment can be considered advantageous in that it is not necessary to perform a separate operating action on the latching element, for example manually taking the latching element out of the latching structure or detaching the latching element from the latching structure, and yet in the loose position it is possible to rotate the first receiving unit and the second receiving unit out of the intended angular setting.

In particular, in this connection, it is considered particularly advantageous when the latching element has a latching tip which interacts with the latching structure, wherein the latching tip has an opening angle of 40° to 90°, preferably of 45° to 65° particularly preferably of 50° to 60°.

The aforementioned angle range has the effect that the latching tip interacts with the latching structure in such a way that a laterally acting force component, as arises between the latching structure and the tip of the latching element when the first receiving unit and the second receiving unit are being rotated in relation to one another, is effected counter to the restoring force exerted by the spring-force element, resulting in a lifting movement of the latching element perpendicularly to the lateral movement. In the aforementioned angle range, the latching force is great enough to feel a sufficient resistance and yet to achieve a lifting movement of the latching element given moderate torques or a moderate expenditure of force for rotating the receiving units in relation to one another out of the intended angular setting, insofar as a situation in which the receiving units are prevented from rotating by the latching unit can be avoided. In addition, the aforementioned angle ranges have proven advantageous for bringing about a sufficient latching force in the adjustment state in order to ensure that the counter element is carried along by the latching element when the receiving units are being rotated.

In one preferred refinement, it is provided that the latching structure is formed on an end face of the counter element facing towards the first receiving unit. Such a design can be considered advantageous in particular against the background of mounting and dismounting of the first receiving unit on and from the second receiving unit, since mounting or dismounting is typically carried out along the axis of rotation and therefore, when the latching element is pre-mounted in the first receiving unit and the counter element is pre-mounted in the second receiving unit, it is ensured that the latching element comes into contact with the end face of the counter element, in particular without needing to perform further actions.

In principle, however, it is also conceivable for the latching structure to be formed on a circumferential surface of the counter element and the latching element to be in contact with the circumferential surface. Accordingly, in such an embodiment, the latching element would be aligned at an angle, in particular perpendicularly, in relation to the axis of rotation.

It is considered particularly advantageous when the latching element has an end portion facing away from the counter element, wherein the end portion passes through the first receiving unit. It is considered particularly advantageous when the end portion protrudes from an end face of the first receiving unit facing away from the second receiving unit. The extent of the protrusion of the end portion from the end face of the first receiving unit can then be taken as a basis to draw a conclusion on whether the latching element is latched in the latching structure and therefore the two receiving units are in the intended angular setting or not.

In this connection, it is considered particularly advantageous when the latching element is captively secured in the first receiving unit by means of a securing ring connected to the end portion.

In a particularly preferred embodiment, it is provided that the first receiving unit has a first friction surface and the second receiving unit has a second friction surface, wherein, in the clamped position, the first receiving unit and the second receiving unit are pressed against one another along the axis of rotation in such a way that the friction surfaces interact force-lockingly, or with frictional engagement, in order to fix the receiving units in place without the ability to rotate.

In this case, it is considered particularly advantageous when the at least one of the first friction surface and the second friction surface has one or more springs extending concentrically with the axis of rotation and the other of the first friction surface and the second friction surface has one or more grooves extending concentrically with the axis of rotation and corresponding to the one or more springs, wherein, in the clamped position, the one or more springs of the respective friction surface are in a force fit, or frictional engagement, with the other one or more grooves of the respective other friction surface.

As regards the transfer of the receiving units from the loose position into the clamped position, it is considered advantageous when the rod connector device has an actuation device for transferring the first receiving unit and the second receiving unit from the loose position into the clamped position along the axis of rotation and for holding the receiving units in the clamped position, wherein the actuation device has a shaft element passing through the first receiving unit along the axis of rotation, wherein the shaft element has a threaded portion, wherein the second receiving unit has a mating threaded portion, wherein the threaded portion of the shaft element is screwed into the mating threaded portion, wherein an axis of the shaft element coincides with the axis of rotation.

It is by all means conceivable for the shaft element to be in the form of a screw.

Further, it is conceivable for the actuation device to have an actuation lever which interacts with the shaft element to transfer the first receiving unit and the second receiving unit from the loose position into the clamped position.

The method according to the invention is used to hold a terminal on a wheelchair. It is provided that, for the purpose of holding the terminal, a linkage is attached to the wheelchair, wherein the linkage has at least a first rod and a second rod, wherein the first rod and the second rod are connected to one another via the rod connector device according to the invention.

The above statements regarding the advantages and advantageous refinements of the rod connector device apply, mutatis mutandis, to the method, and vice versa.

### BRIEF DESCRIPTION OF DRAWINGS

In the following figures, the invention is explained in more detail on the basis of exemplary embodiments, without being limited thereto. In these figures:

FIG. 1 shows a perspective view of an arrangement of a first rod and a second rod, wherein the first and the second rod are connected to one another by means of a first embodiment of a rod connector device, in an intended angular setting,

FIG. 2 shows a perspective view of the arrangement according to FIG. 1 in a folded-up position,

FIG. 3 shows a perspective view of the rod connector device according to FIG. 1,

FIG. 4 shows an exploded representation of the rod connector device according to FIG. 3,

FIG. 5 shows a plan view, in the axial direction along the arrow V in FIG. 6, of the rod connector device according to FIG. 3,

FIG. 6A shows a sectional view, along the line B-B in FIG. 5, of the rod connector device in a first state (locking state and clamped position),

FIG. 6B shows a sectional view, along the line B-B in FIG. 5, of the rod connector device in a second state (adjustment state and loose position),

FIG. 7 shows an enlarged representation of a partial region of FIG. 6A,

FIG. 8A shows a sectional view, along the line A-A in FIG. 5, of the rod connector device in the first state as in FIG. 6A,

FIG. 8B shows a sectional view, along the line B-B in FIG. 5, of the rod connector device in the second state as in FIG. 6B,

FIG. 9 shows a perspective view of a second receiving unit of the rod connector device according to FIG. 3,

FIG. 10 shows an exploded representation of components of an arresting unit that are mounted in the second receiving unit,

FIG. 11 shows a plan view, in the axial direction along the arrow XI in FIG. 13, of the components of the arresting unit,

FIG. 12 shows a sectional view, along the line A-A in FIG. 11, of the components,

FIG. 13 shows a sectional view, along the line B-B in FIG. 11, of the components,

FIG. 14 shows an arrangement of a wheelchair and a terminal attached to the wheelchair via a holding arrangement,

FIG. 15 shows a perspective view of the holding arrangement,

FIG. 16 shows components of a further embodiment of a latching unit in a perspective view,

FIG. 17 shows an exploded representation of the components.

### DETAILED DESCRIPTION

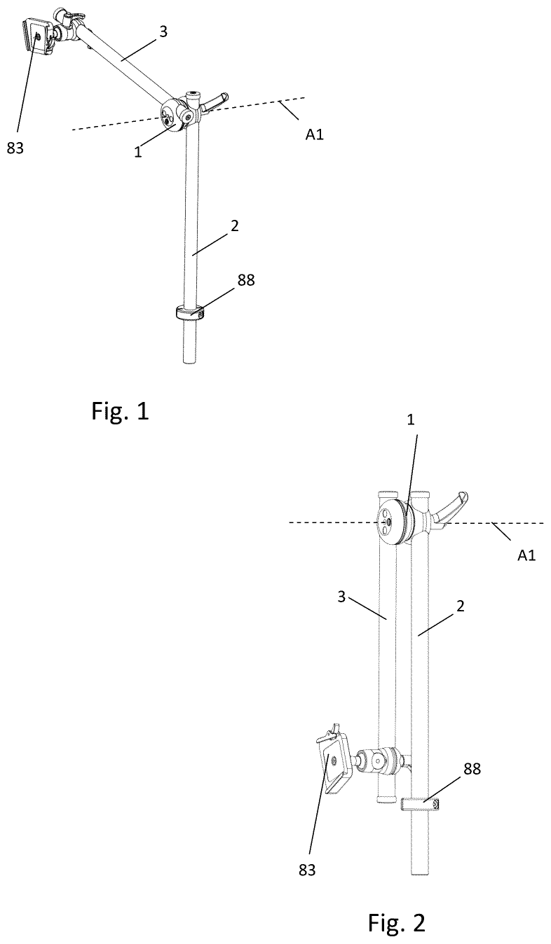

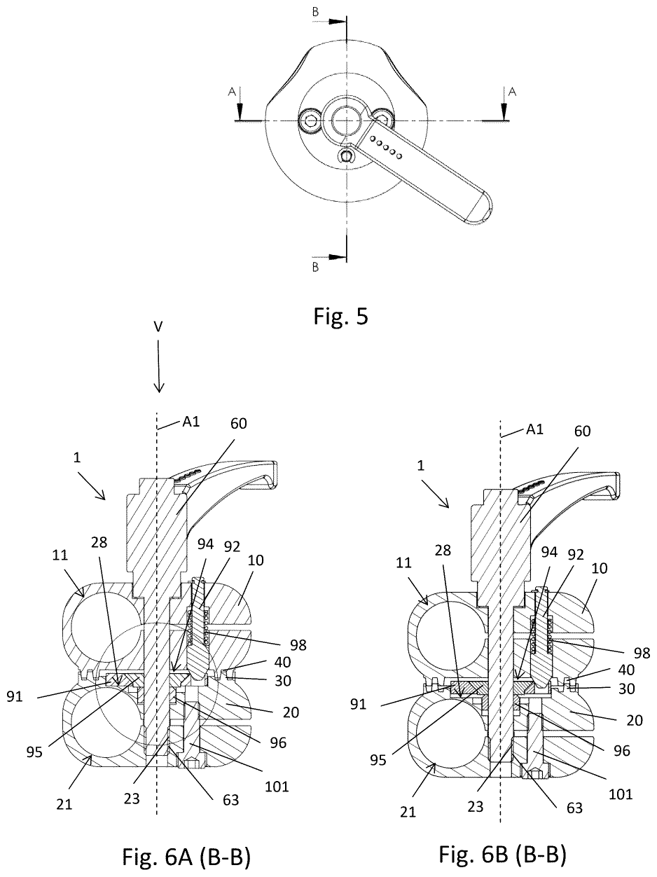

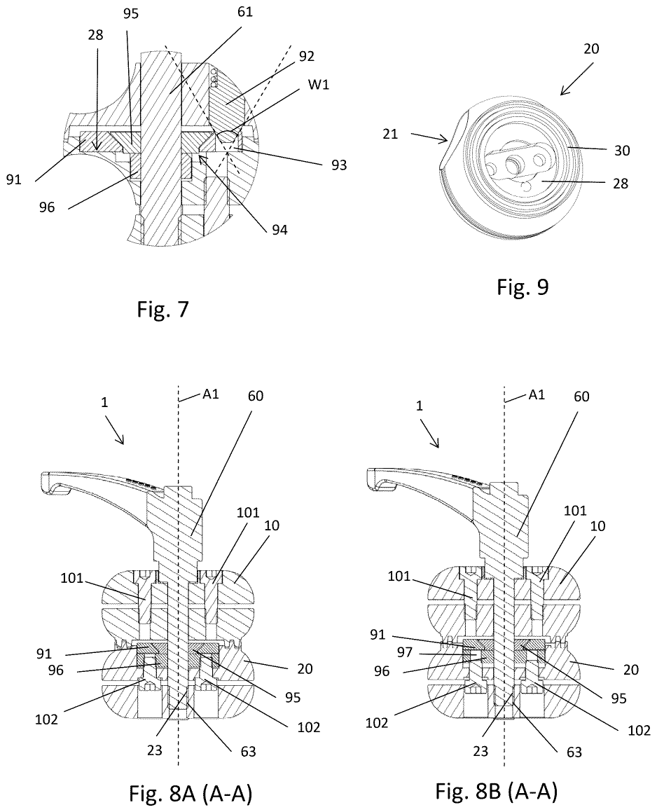

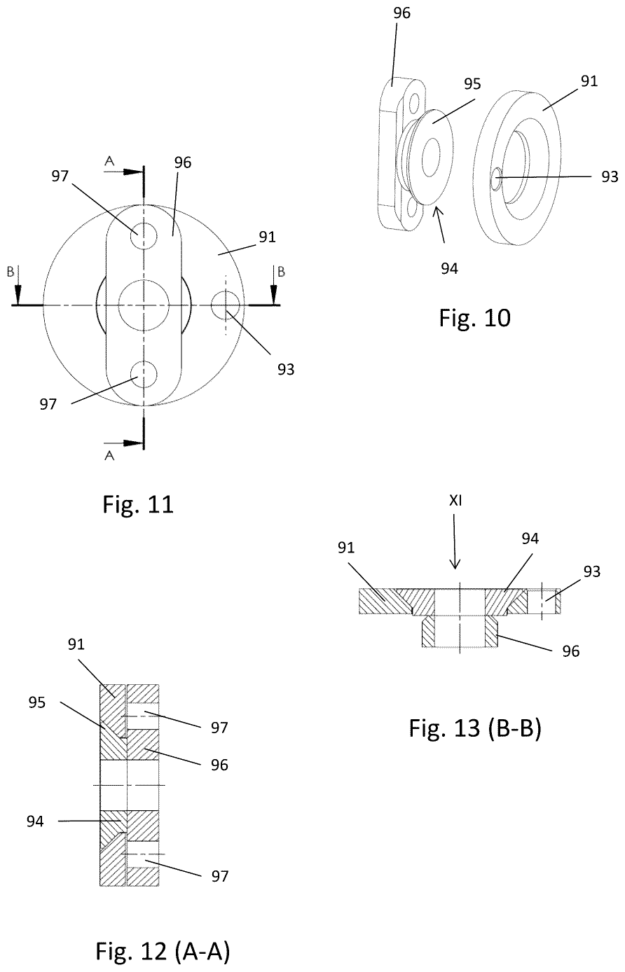

FIGS. 1 to 7 show a first embodiment of a rod connector device 1. FIG. 1 shows an arrangement of a first rod 2 in the form of a tube and a second rod 3 in the form of a tube, the first rod 2 and the second rod 3 being connected to one another via the rod connector device 1.

The rod connector device 1 is used for variable connection at a stable angle of the first rod 2 and the second rod 3. The rod connector device 1 makes it possible to continuously change the angle setting between the first rod 2 and the second rod 3 about the axis of rotation A1, in order to set a desired angle between the first rod 2 and the second rod 3 and then fix the angle that has been set.

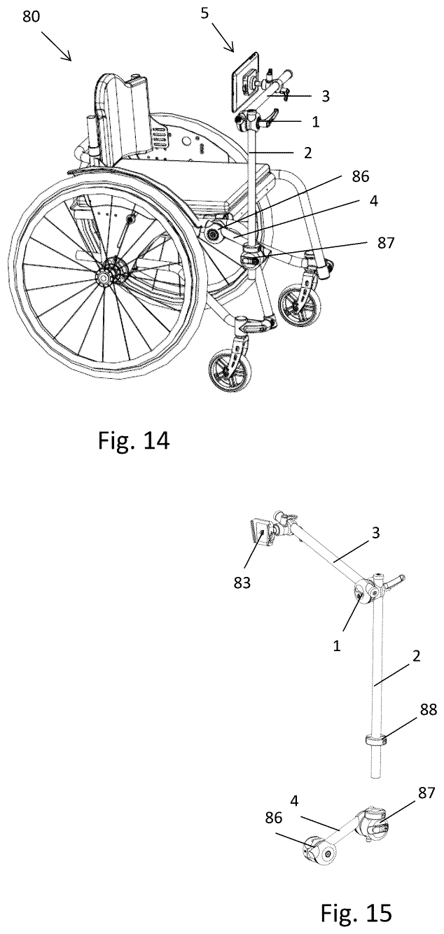

FIG. 14 shows an exemplary field of application of the arrangement as shown in FIG. 1. In this case, the arrangement according to FIG. 1 serves to attach a terminal 5 to a wheelchair 80. A frame clamp 86 is attached to the wheelchair 80. The frame clamp 86 receives a connecting rod 4 such that it can longitudinally move and its angle can be adjusted. A swivel joint 87 is clamped to the opposite end of the connecting rod 4 to the frame clamp 86. The swivel joint 87 receives the first rod 2, wherein a latching disc 88 is fixedly clamped on the first rod 2, the latching disc 88 interacting with the swivel joint 87 to allow the first rod 2 to swivel about its longitudinal axis in the swivel joint 87 by predefined angles. The first rod 2 is aligned substantially vertically, whereas the second rod 3 is aligned substantially horizontally.

A terminal mount 83 is mounted on the second rod 3, which is connected to the first rod 2 via the rod connector device 1. The terminal mount 83 has a bearing receptacle for the terminal 5. The end device 5, which in the present case is a tablet computer, is received in the bearing receptacle and as a result positionally fixed with respect to the wheelchair 80. In the arrangement shown in FIG. 14, the first rod 2 and the second rod 3 are in a use position, the position being defined in that the first rod 2 and the second rod 3 are in an intended angular setting, so that the terminal 5 is exactly aligned for the user for its intended use. The second rod 3 and the first rod 2 are aligned approximately perpendicularly in relation to one another, and therefore the intended angular setting is about 90°.

When the person using the wheelchair is for example going to be transported by car or by school bus, the terminal 5 is separated from the terminal mount 83 and the first rod 2 is removed from the swivel joint 87. This state is shown in FIG. 15. In order to make it possible to space-savingly stow the linkage arrangement removed from the swivel joint 87, the first rod 2 and the second rod 3 are transferred from the intended angular setting shown in FIG. 1 into a folded-up position shown in FIG. 2. The rod connector device 1 makes the folding-up possible.

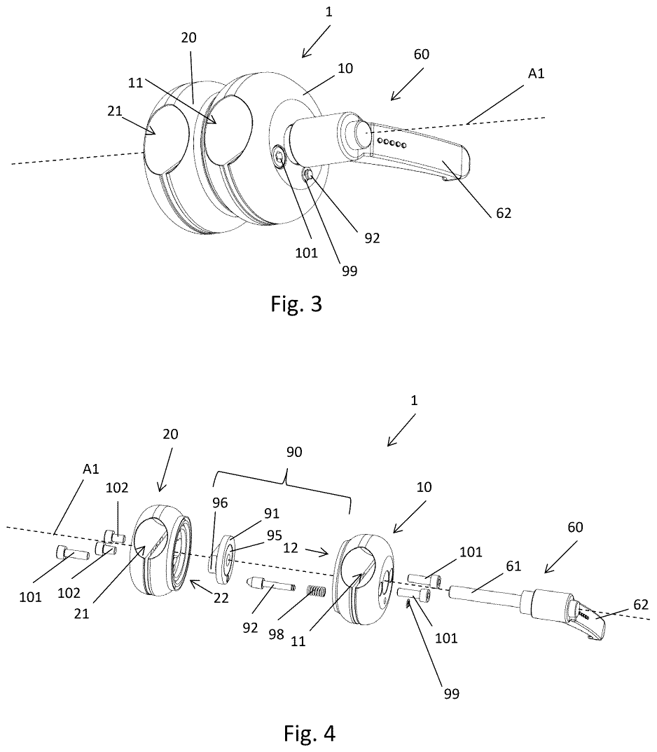

The rod connector device 1 is represented in more detail in FIGS. 3 to 8B. The rod connector device 1 has a first receiving unit 10, the first receiving unit 10 having a first rod receptacle 11 for the first rod 2. The rod connector device 1 further has a second receiving unit 20, the second receiving unit 20 having a second rod receptacle 21 for the second rod 3. The first and the second rod receptacle 11, 21 are each in the form of cross-sectionally circular through-openings, the respective receiving unit 10, 20 being slotted to enable a narrowing of the through-openings for the purpose of clamping the respective rod 2, 3 in the rod receptacle 11, 21. The respective rod 2, 3 is clamped in the respective rod receptacle 11, 21 via the clamping screws 101.

The first receiving unit 10 and the second receiving unit 20 are mechanically coupled to one another by an actuation device 60. The actuation device 60 has a shaft element 61, the shaft element 61 passing through the first receiving unit 10 such that the receiving unit 10 is mounted on the shaft element 61 with the ability to rotate about the axis of rotation A1. The shaft element 61 has a threaded portion 63, wherein the second receiving unit 20 has a mating threaded portion 23 corresponding to the threaded portion 63, the threaded portion 63 of the shaft element 61 being screwed in the mating threaded portion 23 as can be seen in particular in FIGS. 6A, 6B and 8A and 8B. Via the actuation device 60, the first receiving unit 10 and the second receiving unit 20 can be moved towards one another along the axis of rotation A1 by screwing the shaft element 61 into the mating threaded portion 23 of the second receiving unit 20, pressed together as a result and in this way transferred from a loose position into a clamped position, as described in more detail below.

FIGS. 6A and 8A show the receiving units 10, 20 in their clamped position. FIGS. 6B and 8B show the receiving units 10, 20 in their loose position. The clamped position differs from the loose position in that, in the clamped position, the shaft element 61 is screwed further in the second receiving unit 20, as a result of which the first receiving unit 10 and the second receiving unit 20 are pressed together along the axis of rotation A1. By contrast, in the loose position the shaft element 61 is screwed in the second receiving unit 20 to a lesser extent, so that the first receiving unit 10 and the second receiving unit 20 are not pressed together along the axis of rotation A1. In order to make it easier to screw in and unscrew the shaft element 61 into and from the second receiving unit 20, the actuation device 60 has an actuation lever 62. Often, such a configuration of the actuation device in combination with the rod connector device is also referred to as a “clamping lever”.

In the clamped position, a first friction surface 12 of the first receiving unit 10 and a second friction surface 22 of the second receiving unit 20 are in contact with one another in such a way that the receiving units 10, 20 are fixed in place in relation to one another in the clamped position without the ability to rotate. Accordingly, in the clamped position, the first receiving unit 10 and the second receiving unit 20 are fixed in place in relation to one another at a stable angle by the first friction surface 12 and the second friction surface 22 being in force-fitting interaction. By contrast, in the loose position the first friction surface 12 and the second friction surface 22 are spaced apart from one another in the axial direction of the axis of rotation A1, as a result of which it is possible to rotate the receiving units 10, 20 in relation to one another about the axis of rotation A1 in the loose position, in order to vary an angle between the receiving units 10, 20.

In order to obtain particularly high static friction between the first friction surface 12 and the second friction surface 22 in the clamped position, the first friction surface 12 has a groove 40 extending concentrically with the axis of rotation A1. The second friction surface 22 has a spring 30, which corresponds to the groove 40 and extends concentrically with the axis of rotation A1.

In the clamped position represented in FIGS. 6 and 8, the first receiving unit 10 and the second receiving unit 20 are pressed against one another along the axis of rotation A1 by the actuation device 60 in such a way that the spring 30 of the second friction surface 22 is driven into the groove 40 of the first friction surface 12 in such a way that flanks of the spring 30 extensively abut the flanks of the groove 40, this bringing about a force fit between the spring 30 and the groove 40 for fixing the receiving units 10, 20 in place, without the ability to rotate, in the angular setting present on transfer into the clamped position.

The rod connector device 1 has an arresting unit 90 for finding a settable intended angular setting again. The arresting unit 90 makes it possible to easily find again the intended angular setting as shown in FIG. 1, for example in order to quickly and easily find the intended angular setting again when a holding arrangement has been folded up, in order to set up the correct position for the terminal 5 with respect to the wheelchair 80.

The arresting unit 90 has components mounted in the first receiving unit 10 and further components mounted in the second receiving unit 20.

The arresting unit 90 has a latching element 92 mounted in the first receiving unit 10. The latching element 92 is a latching pin in the present case. The latching element 92 has a bevelled latching tip which is flattened at the end and has an opening angle W1 of 60° in the present case. The latching element 92 is axially movably mounted in the first receiving unit 10 and is radially offset in relation to the axis of rotation A1. In this case, a spring-force element 98 applies a spring force to the latching element 92 in the direction of the second receiving unit 20. An end portion of the latching element 92 protrudes on an end face of the first receiving unit 10 facing away from the second receiving unit 20 and is captively mounted in the first receiving unit 10 by means of a shaft securing ring 99.

A counter element 91 which has a latching structure 93 in the form of a through-hole is mounted in the second receiving unit 20. The counter element 91 is annular and the latching structure 93 is radially offset in relation to the axis of rotation A1. The latching structure 93 is configured to arrestingly interact with the latching element 92 in such a way that, when the first receiving unit 10 and the second receiving unit 20 are rotated in relation to one another about the axis of rotation A1 on reaching the intended angular setting, the latching element 92 arrestingly interacts with the latching structure 93 of the counter element 91. If the receiving units 10, 20 are for example in the starting position shown in FIG. 2, and thus in the folded-up position, the latching element 92 and the latching structure 93 are accordingly not in engagement. If the receiving units 10, 20 are now to be transferred into the intended angular setting, the first receiving unit 10 and the second receiving unit 20 are transferred into the loose position and then rotated in relation to one another about the axis of rotation A1 until the latching element 92 audibly and perceptibly latches into the latching structure 93 of the counter element 91 under the influence of the force exerted by the spring-force element 98. The arresting interaction of the latching element 92 with the latching structure 93 indicates to the user that the two receiving units 10, 20 are in the desired intended angular setting. This makes it easier to transfer the receiving units 10, 20 into the intended angular setting via the arresting unit 90. After the intended angular setting has been reached, the receiving units 10, 20 can then be transferred into the clamped position.

The arresting unit 90 is furthermore configured such that it is possible to adjust the intended angular setting by changing the angular position of the latching structure 93 in relation to the second receiving unit 20. For this purpose, the counter element 91 can be transferred from a locking state shown in FIGS. 6A and 8A into an adjustment state shown in FIGS. 6B and 8B. In order to make it possible to find the intended angular setting again by means of the latching unit 90, it is necessary for the counter element 91 to be locked in the second receiving unit 20 in such a way that the counter element 91 is mounted in the second receiving unit 20 without the ability to rotate. This state corresponds to the locking state. In order to make it possible to adjust the intended angular setting, by contrast it is necessary for it to be possible to change the angular position of the latching structure 93 in the second receiving unit 20. For this purpose, the counter element 91 can be transferred into the adjustment state, in the adjustment state the counter element 91 being mounted in the second receiving unit 20 with the ability to rotate about the axis of rotation A1.

In order to transfer the counter element 91 from the locking state into the adjustment state and vice versa, the arresting unit 90 has a bracing element 94. The counter element 91 is mounted on the bracing element 94. The bracing element 94 has a bracing portion 95. The second receiving unit 20 has a pressing surface 28 for the counter element 91. The counter element 91 is located between the bracing portion 95 and the pressing surface 28. In order to lock the counter element 91 in the second receiving unit 20, the bracing element 94 is axially movably mounted in the second receiving unit 20. By tightening the bracing element 94 in the direction of the pressing surface 28, the counter element 91 is transferred to the locking state shown in FIGS. 6A and 8A. In the present case, in the locking state the counter element 91 is clamped between the bracing portion 95 and the pressing surface 28 in such a way that the force fit, or frictional engagement, between the counter element 91 and the bracing portion 95 and the force fit, or frictional engagement, between the counter element 91 and the pressing surface 28 cause the counter element 91 to be held in the second receiving unit 20 without the ability to rotate. Fundamentally, the counter element 91 is mounted on the bracing element 94 with the ability to rotate. Accordingly, in the adjustment state shown in FIGS. 6B and 8B, in which the bracing portion 95 is spaced further apart from the pressing surface 28 than in the locking state, the counter element 91 is located between the bracing portion 95 and the contact surface 28 with axial play and as a result the counter element 91 is rotatable in relation to the second receiving unit 20 about the axis of rotation A1. In the adjustment state, the angular setting of the counter element 91 and thus of the latching structure 93 can accordingly be changed in relation to the second receiving unit 20.

In the embodiment shown in the figures, the bracing portion 95 has an axially variable outside diameter, wherein the variable outside diameter forms an outer cone, the counter element 91 having an inner cone corresponding to the outer cone. Due to the conical shape of the bracing portion 95 and the inner cone of the counter element 91, particularly high axial force absorption is enabled.

The bracing element 94 is tightened by tightening clamping screws 102. The clamping screws 102 pass through the second receiving unit 20 in the axial direction and their screw heads are supported on the second receiving unit 20 on a side facing away from the first receiving unit 10. The clamping screws 102 are screwed in threaded portions 97 of a mounting element 96, the mounting element 96 being connected, specifically welded, to the bracing element 94. Tightening the clamping screws 102 causes the mounting element 96 and thus the bracing element 94 to be pulled into the second receiving unit 20, as a result of which the bracing portion 95 pulls the counter element 91 against the pressing surface 28.

In order to change or set the intended angular setting, the following can be performed:

Firstly, the clamping screws 102 are loosened in order to transfer the counter element 91 from the locking state, in which the counter element 91 is held in force-fittingly between the pressing surface 28 and the bracing portion 95, into the adjustment state, in which the counter element 91 is freely rotatable about the axis of rotation A1 in the second receiving unit 20. Then, the first receiving unit 10 and the second receiving unit 20 are transferred from the clamped position into the loose position by actuating the actuation device 60, specifically by taking the shaft element 61 out of the second receiving unit 20 or detaching it therefrom. The subsequent state of the rod connector device 1, specifically the counter element 91 being in the adjustment state and the first receiving unit 10 and second receiving unit 20 being in the loose position, is shown in FIGS. 6B and 8B. Both the bracing screws 102 and the shaft element 61 are not unscrewed completely, but only to the extent that it is possible to rotate the counter element 91 in the second receiving unit 20 and rotate the receiving units 10, 20 in relation to one another. Owing to the spring force exerted by the spring-force element 98, the bevelled latching tip of the latching element 92 stays latched in the latching structure 93, which is in the form of a through-opening, of the counter element 91. As a result, the latching element 92 carries along the counter element 91 when the first receiving unit 10 and the second receiving unit 20 are rotated in relation to one another about the axis of rotation A1, with the result that the angular position of the latching structure 93 in the second receiving unit 20 corresponds to the current angular setting of the two receiving units 10, 20 in relation to one another. By tightening the bracing screws 102, the counter element 91 is then locked in the currently set or present angular setting, in order as a result to determine the intended angular setting. Further, by tightening the shaft element 61 the receiving units 10, 20 are fixed in place in relation to one another without the ability to rotate. The subsequent state of the rod connector device 1, specifically the counter element 91 being in the locking state and the first receiving unit 10 and second receiving unit 20 being in the clamped position, is shown in FIGS. 6A and 8A.

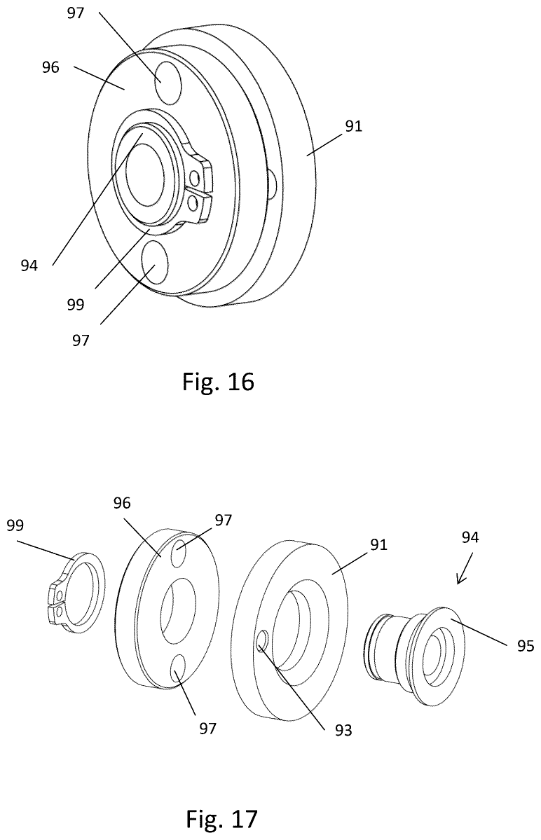

FIGS. 16 and 17 show the components, mounted in the second receiving unit 20, of a arresting unit 90 according to a further embodiment.

This embodiment differs from the above-described embodiment substantially by the shape of the bracing element 94 and the mounting element 96. In the embodiment shown in FIGS. 16 and 17, the bracing element 94 is not connected to the mounting element 96 without the ability to rotate, but is merely axially secured thereto, specifically via a shaft securing ring 99. In detail, the bracing element 94 has a shaft portion adjacent to the bracing portion 95, wherein the shaft portion passes through the annular counter element 91 and the annular mounting element 96, the counter element 91 and the mounting element 96 being axially secured to the bracing element 94 via the shaft locking ring 99 attached to the shaft portion.

### LIST OF REFERENCE SIGNS

1 Rod connector device
2 First rod
3 Second rod
4 Connecting tube
5 Terminal
10 First receiving unit
11 First rod receptacle
12 First friction surface
20 Second receiving unit
21 Second rod receptacle
22 Second friction surface
23 Mating thread portion
30 Spring
40 Groove
60 Actuation device
61 Shaft element
62 Actuation lever
63 Threaded portion
80 Wheelchair
83 Terminal mount
86 Frame clamp
87 Swivel joint
88 Latching disc
90 Arresting unit
91 Counter element
92 Latching element
93 Latching structure
94 Bracing element
95 Bracing portion
96 Mounting element
97 Threaded portion
98 Spring-force element
99 Shaft securing ring
101 Clamping screw
102 Bracing screw
A1 Axis of rotation
W1 Opening angle

1. Rod connector device for variable connection at a stable angle of a first rod and a second rod of a linkage to one another with an arresting unit for finding a settable intended angular setting again, the rod connector device comprising:
a first receiving unit, the first receiving unit having a first rod receptacle for the first rod,
a second receiving unit, the second receiving unit having a second rod receptacle for the second rod,
wherein the first receiving unit and the second receiving unit are coupled to one another and can be transferred from a loose position into a clamped position, wherein the receiving units are rotatable in relation to one another about an axis of rotation in the loose position in order to vary an angle of the receiving units in relation to one another, wherein, in the clamped position, the receiving units are fixed in place without the ability to rotate, wherein the arresting unit has a latching element, which is mounted in the first receiving unit, and a counter element, which is mounted in the second receiving unit and has a latching structure for the latching element, wherein a spring-force element applies a spring force to the latching element in the direction of the counter element, wherein, when the first receiving unit and the second receiving unit are rotated in relation to one another about the axis of rotation in the intended angular setting, the latching element arrestingly interacts with the latching structure of the counter element, wherein the counter element can be transferred from a locking state to an adjustment state, wherein, in the adjustment state, the counter element is mounted in the second receiving unit with the ability to rotate about the axis of rotation in order to set the intended angular setting by changing an angular position of the latching structure in the second receiving unit, wherein, in the locking state, the counter element is mounted in the second receiving unit without the ability to rotate, in order to lock the set intended angular setting in place.

2. Rod connector device according to claim 1, wherein the arresting unit has a bracing element, wherein the bracing element has a bracing portion, wherein the second receiving unit has a pressing surface for the counter element, wherein the bracing element is mounted in the second receiving unit with the ability to move axially, wherein an axial movement of the bracing element causes the counter element to be transferable from the adjustment state into the locking state and vice versa, wherein, in the locking state, the counter element is clamped in the second receiving unit between the bracing portion and the pressing surface, without the ability to rotate owing to a force fit with the bracing portion and with the pressing surface, and, in the adjustment state, the counter element is rotatable with respect to the second receiving unit about the axis of rotation.

3. Rod connector device according to claim 2, wherein the bracing portion has a variable outside diameter forming an outer cone, and wherein the counter element has a variable inside diameter forming an inner cone corresponding to the outer cone.

4. Rod connector device according to claim 2, wherein the bracing element is attached to a mounting element, wherein the mounting element has at least one threaded portion, wherein a screw element is screwed to the threaded portion, wherein rotational tightening of the screw element leads to an axial movement of the bracing portion in the direction of the pressing surface.

5. Rod connector device according to claim 4, wherein the screw element is in the form of a screw with a head portion and the head portion of the screw element is supported during the tightening operation on the second receiving unit on a side of the second receiving unit facing away from the bracing portion.

6. Rod connector device according to claim 2, wherein the bracing element is mounted in the second receiving unit without the ability to rotate.

7. Rod connector device according to claim 1, wherein the counter element is annular.

8. Rod connector device according to claim 1, wherein, in the adjustment state, the latching element interacts with the latching structure of the counter element in such a way that, when the first receiving unit and the second receiving unit are rotated in relation to one another about the axis of rotation, the counter element is carried along by the latching element.

9. Rod connector device according to claim 1, wherein the latching structure is in the form of a recess or through-hole.

10. Rod connector device according to claim 1, wherein the latching element and the latching structure are designed in such a way that, in the locking state, it is possible to rotate the first receiving unit and the second receiving unit in relation to one another out of the intended angular setting by overcoming a latching resistance caused by the latching interaction of the latching element with the latching structure.

11. Rod connector device according to claim 1, wherein the latching element has a latching tip which interacts with the latching structure, wherein the latching tip has an opening angle of 40° to 90°, preferably of 45° to 65°, particularly preferably of 50° to 60°.

12. Rod connector device according to claim 1, wherein the latching structure is formed on an end face of the counter element facing towards the first receiving unit.

13. Rod connector device according to claim 1, wherein the latching element has an end portion facing away from the counter element, wherein the end portion passes through the first receiving unit.

14. Rod connector device according to claim 1, wherein the first receiving unit has a first friction surface and the second receiving unit has a second friction surface, wherein, in the clamped position, the first receiving unit and the second receiving unit are pressed against one another along the axis of rotation in such a way that the friction surfaces force-lockingly interact in order to fix the receiving units in place without the ability to rotate.

15. Method for holding a terminal on a wheelchair, wherein, for the purpose of holding the terminal, a linkage is attached to the wheelchair, wherein the linkage has at least a first rod and a second rod, wherein the first rod and the second rod are connected to one another via a rod connector device according to claim 1.
